(19) United States
(12) Patent Application Publication
(10) Pub. No.: US 2015/0379471 A1
(43) Pub. Date: Dec. 31, 2015

(54) Management system for transmission of electronic business card based on telephone number linkage and method therefor

(71) Applicant: TW MOBILE CO., LTD., Seoul (KR)

(72) Inventors: Se-yong Lee, Seoul (KR); Kyo-sik Hong, Ansung (KR)

(73) Assignee: TW MOBILE CO., LTD., Seoul (KR)

(21) Appl. No.: 14/761,182

(22) PCT Filed: Jan. 17, 2014
(86) PCT No.: PCT/KR2014/000539

§ 371 Date: Jul. 15, 2015

(30) Foreign Application Priority Data
Jan. 17, 2013 (KR) 10-2013-0005603

(51) Int. Cl. G06Q 10/10; H04W 4/14

(52) U.S. Cl. CPC G06Q 10/10; H04W 4/14

(57) ABSTRACT

Disclosed are a management system for transmission of an electronic business card based on a telephone number and a method thereof. The management system for transmission of an electronic business card based on a telephone number is capable of determining whether to transmit an electronic business card based on a personal telephone directory or whether a user's electronic business card is already stored, transmitting the electronic business card only on calling, and managing so as to transmit various electronic business cards depending on the relationship with the user or a time zone.

### TECHNICAL FIELD

The present invention relates to a management system for transmission of an electronic business card based on a telephone number and a method thereof, and more particularly, to a management system for transmission of an electronic business card based on a telephone number which is capable of determining whether to transmit an electronic business card based on a personal telephone directory or whether a user's electronic business card is already stored, transmitting the electronic business card only on calling, and managing so as to transmit various electronic business cards depending on the relationship with the user or a time zone, and a method thereof.

### BACKGROUND ART

As known in the art, with the recent development of information communication technologies, a development of information providing technologies which provide information on various fields to a plurality of subscribers through at least one host server via a wide area data communication network in real time has been actively progressed.

In connection with this development, a peripheral technology, such as a cache memory extension technology for more rapidly providing accurate information to subscribers, an information selection technology for more conveniently accessing taste and preference of the subscribers, and a compression technology have been developed. Further, attempts to develop various contents and solutions thereof based on these technologies have been actively conducted.

Further, with the recent breakthrough of electronic communication technologies, various programs based on a desk top PC have been developed, and applications based on mobile communication terminal such as a smart phone and a tablet PC have been actively conducted.

In particular, with the rapid spread of the mobile communication terminals such as a smart phone and a tablet PC which are personal communication devices, various customer-tailored applications such as security, advertisement, and smart banking application to improve the use convenience of the mobile communication terminals have been actively developed.

One of the mobile communication terminal based technologies is an electronic business card related technology. The electronic business card means a digital business card which may be produced as digital data, may be conveniently transmitted to a mobile communication terminal of an opponent, and may be conveniently stored in the mobile communication terminal of the opponent.

However, the electronic business card has some problems as follows.

First, when the electronic business card is again transmitted to the opponent whose mobile communication terminal already stores the user's electronic business card, the opponent is likely to have an unfavorable impression on the user.

Second, when the user's electronic business card is automatically transmitted even to unwanted opponents, the user's electronic business card may be used in a crime such as voice fishing.

Third, the same electronic business card may be transmitted to the opponents independent of how they are related to the user. Therefore, there is a need to transmit various electronic business cards to the opponents depending on the relationship with the user.

Fourth, the same electronic business card may be transmitted independent of whether the user is on duty or whether the user is off duty. Therefore, there is a need to transmit various electronic business cards to the opponents depending on a time zone.

### DISCLOSURE

### Technical Problem

In consideration of the above-mentioned circumstances, it is an object of the present invention to provide a management system for transmission of an electronic business card based on a telephone number which is capable of determining whether to transmit an electronic business card based on a personal telephone directory or whether a user's electronic business card is already stored, transmitting the electronic business card only on calling, and managing so as to transmit various electronic business cards depending on the relationship with the user or a time zone, and a method thereof.

In order to accomplish the above object, there is provided a management system for transmission of an electronic business card based on a telephone number, including: a sender terminal 2 including an electronic business card managing application 6 which is loaded therein to determine whether a telephone number of a receiver is already stored in a telephone number directory of a sender, and send an electronic business card to only a receiver terminal 4 of which the telephone number is not yet stored, on requesting a transmission of a short message receiving signal or a telephone call signal to the receiver terminal 4; the receiver terminal 4 including the electronic business card managing application 6 which is loaded therein to output the electronic business card on a screen thereof when the short message receiving signal or the telephone call signal is received from the sender terminal 2 and the sender's electronic business card is received from an electronic business card relay server 10, and the electronic business card relay server 10 configured to receive a request signal for the relay of the electronic business card from the sender terminal 2 and transmit the electronic business card of the corresponding sender to the receiver terminal 4.

Preferably, the electronic business card managing application 6 of the sender terminal 2 is an application which is linked with the telephone number directory of the sender stored in the sender terminal 2 to read a telephone number.

Preferably, the sender terminal 2 includes: a telephone communication unit 12 which includes a key input unit 18 configured to input a telephone number of a specific opponent and generate a telephone call signal or a short message sending request signal, a receiving unit 14 and a sending unit 16 configured to process the receiving and sending of the voice communication or short message transmission and reception, and a receiving/sending control unit 20 configured to generate a receiving or sending signal to the receiving unit 14 and the sending unit 16; and a digital business managing unit 22 which includes a user telephone number storage unit 24 configured to store telephone numbers of a plurality of acquaintances, an electronic business card storage unit 26 configured to store a sender's electronic business card, an electronic business card sending control unit 28 configured to receive a signal of voice communication or short message transmission and reception from the receiving/sending control unit 20 to determine whether the telephone number of the corresponding receiver is present in the user telephone number storage unit 24, and control so as to transmit the electronic business card if it is determined that the telephone number of the corresponding receiver is not present therein; and an electronic business card transmitting unit 30 configured to transmit the electronic business card.

Preferably, the receiver terminal 4 is configured to transmit the electronic business card to the sender terminal 2 when receiving the signal of the voice communication or the short message reception.

Preferably, the sender terminal 2 and the receiver terminal 4 have a manual transmitting function provided in the electronic business card managing application 6 so as to transmit the electronic business card to the opponent terminal by a key operation, on the separate request of the communication opponent.

Preferably, the electronic business card storage unit 26 is configured to store various electronic business cards for each detailed classification of a family, a friend, a senior, and a junior, and the electronic business card sending control unit 28 is configured to determine whether the telephone number of the opponent belongs to any detailed classification, and control so as to extract and transmit the corresponding electronic business card.

Preferably, the electronic business card storage unit 26 is configured to store various electronic business cards for each detailed classification of an existing customer and a desired customer, and the electronic business card sending control unit 28 is configured to determine whether the telephone number of the opponent belongs to any detailed classification, and control so as to extract and transmit the corresponding electronic business card.

Preferably, the electronic business card managing application 6 included in the sender terminal 2 is configured to manage the electronic business card to automatically replace the electronic business card by another electronic business card depending on time.

Preferably, wherein electronic business card storage unit 26 included in the sender terminal 2 is configured to store a representative electronic business card and store various electronic business cards at each time zone of weekday, weeknight, and holiday; and the electronic business card sending control unit 28 is configured to determine whether the telephone number of the opponent is included in any time zone, and control so as to extract and transmit the corresponding electronic business card.

Preferably, the sender terminal 2 and the receiver terminal 4 communicate with each other by the electronic business card managing application 6 loaded therein, and confirm whether the electronic business card of the sender is stored in the receiver terminal 4 to prevent the electronic business card from being repeatedly sent.

Preferably, the electronic business card relay server 10 is an SMS server or an MMS server.

Preferably, the electronic business card relay server 10 transmits the electronic business card to the receiver terminal 4 by a push scheme.

According to the present invention there is provided an electronic business card transmission-managing method, including: a first step of receiving, by a sender terminal 2, a telephone number of an opponent user to whom voice communication or short message is transmitted; a second step of determining, by the sender terminal 2, whether the opponent user is an object to whom the electronic business card is transmitted; a third step of performing, by the sender terminal 2, the transmission of voice communication or short message if it is determined that the opponent user is not the object to whom the electronic business card is transmitted, and a fourth step of transmitting, by the sender terminal 2, the electronic business card to the corresponding receiver terminal 4 if it is determined that the opponent user is the object to whom the electronic business card is transmitted, and performing the transmission of voice communication or short message.

Preferably, the method further includes: before the first step, registering, by the sender terminal 2, the electronic business card.

Preferably, the second step includes: a step of comparing, by the electronic business card managing application 6 loaded in the sender terminal 2, the telephone number of the opponent user with the telephone number stored in a telephone directory of the sender; a step of determining whether the corresponding telephone number is stored in the telephone directory of the sender; a step of determining the corresponding telephone number to be an object to whom the electronic business card is transmitted if it is determined that the corresponding telephone number is not stored in the telephone directory of the sender.

Preferably, the second step determines the opponent user to be the object to whom the electronic business card is transmitted when the sender terminal 2 receives an electronic business card request signal from the receiver terminal 4.

Preferably, the second step determines the opponent user to be the object to whom the electronic business card is transmitted when the electronic business card is not stored in the receiver terminal 4, by the communication between the electronic business card managing application 6s loaded in the sender terminal 2 and the receiver terminal 4.

Preferably, the fourth step includes: a step of determining, by the electronic business card managing application 6 of the sender terminal 2, whether the telephone number of the receiver terminal 4 belongs to any classification of the telephone number directory of the sender terminal 2; and a step of extracting the electronic business card stored in each corresponding classification.

Preferably, the classification of the telephone directory of the sender terminal 2 is divided into a family, a friend, a senior, a junior, an exist customer, and a desired customer.

Preferably, the fourth step includes: a step of determining, by the electronic business card managing application 6 of the sender terminal 2, whether a time connected electronic business card replacement mode is set; a step of determining whether a current time belongs to any time zone; and a step of extracting the electronic business card matched the corresponding time zone.

Preferably, various electronic business cards are stored by matching the time zone of a weekday, a weeknight, and a holiday.

Preferably, the method further includes: a step of extracting, by the electronic business card managing application 6 of the sender terminal 2, a representative electronic business card, on releasing the time connected electronic business card replacement mode.

### Advantageous Effects

In accordance with the management system for transmission of an electronic business card based on a telephone number and a method thereof according to the present invention, it is possible to determine whether to transmit the business digital card to the opponent by linking the applications loaded in the mobile communication terminal with the personal telephone directory built in the corresponding terminal, prevent the repetitive transmission for the opponent not to feel the business digital card as a spam mail, and easily receive the electronic business card through the communication between the applications without any explanation at the time of requesting the electronic business card to the receiver, thereby greatly improving the convenience.

### DESCRIPTION OF DRAWINGS

FIG. 1 is a diagram illustrating a schematic configuration of a telephone number based management system for transmission of an electronic business card according to an embodiment of the present invention.

FIG. 2 is a diagram illustrating a state in which the telephone number based management system for transmission of an electronic business card according to the embodiment of the present invention transmits and processes an electronic business card based on a telephone directory.

FIG. 3 is a block diagram illustrating a configuration of a user terminal included in the telephone number based management system for transmission of an electronic business card according to the embodiment of the present invention.

FIG. 4 is a flow chart illustrating a step of transmitting and processing, by the telephone number based management system for transmission of an electronic business card according to the embodiment of the present invention, the electronic business card based on a telephone directory.

FIG. 5 is a flow chart illustrating a step of transmitting an electronic business card through applications included in the telephone number based management system for transmission of an electronic business card according to the embodiment of the present invention.

FIG. 6 is a diagram illustrating a state in which the electronic business cards for each relationship with a user are built by the telephone number based management system for transmission of an electronic business card according to the embodiment of the present invention.

FIG. 7 is a diagram illustrating a state in which the electronic business cards to be transmitted at each time zone is built by the telephone number based management system for transmission of an electronic business card according to the embodiment of the present invention.

FIG. 8 is a flow chart illustrating a step of transmitting electronic business cards at each time zone by the telephone number based management system for transmission of an electronic business card according to the embodiment of the present invention.

FIG. 9 is a diagram for describing another function of digital business managing applications included in the telephone number based management system for transmission of an electronic business card according to the embodiment of the present invention.

### BEST MODE

Hereinafter, the present invention will be described with reference to the accompanying drawings.

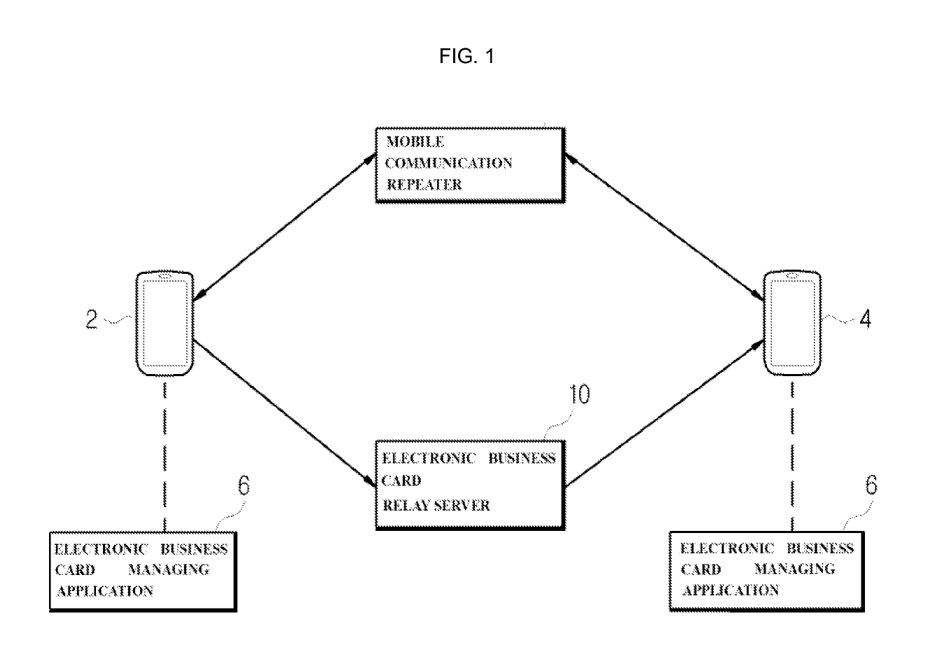

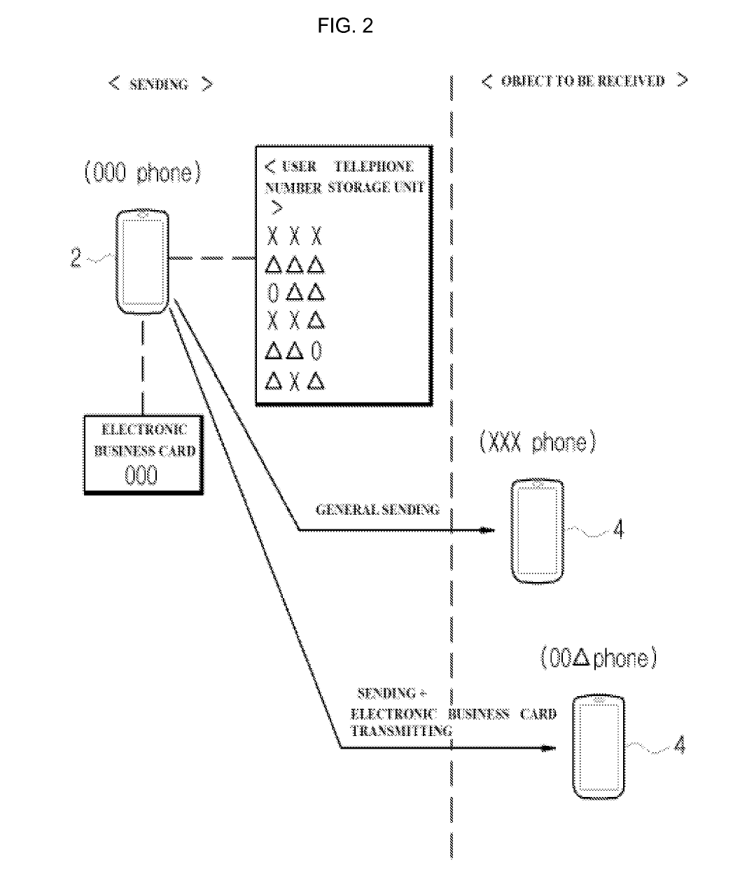

FIG. 1 is a diagram illustrating a schematic configuration of a telephone number based management system for transmission of an electronic business card according to an embodiment of the present invention, and FIG. 2 is a diagram illustrating a state in which the telephone number based management system for transmission of an electronic business card according to the embodiment of the present invention transmits and processes an electronic business card based on a telephone directory.

Referring to FIGS. 1 and 2, the telephone number based management system for transmission of an electronic business card according to the embodiment of the present invention determines whether to transmit the electronic business card based on a personal telephone directory or whether a user's electronic business card is already stored, transmits the electronic business card only on calling, and manages so as to transmit various electronic business cards depending on the relationship with the user or a time zone.

In more detail, the telephone number based management system for transmission of an electronic business card according to the embodiment of the present invention may transmit the electronic business card as long as a sender generates a short message or telephone call signal to a specific receiver. In particular, the inventive management system determines whether the corresponding receiver is an object to whom the electronic business card is transmitted, and then automatically transmits the electronic business card only when the object to whom the electronic business card is transmitted.

Both of the determination on a sender and the determination on whether an opponent is the object to whom the electronic business card is transmitted are processed by an electronic business card managing application 6 loaded in a corresponding sender terminal 2.

The electronic business card managing application 6 serves to output an electronic business card on a screen thereof and communicates with the electronic business card managing application 6 loaded in an opponent terminal to request the electronic business card.

In more detail, the telephone number based management system for transmission of an electronic business card according to the embodiment of the present invention includes a sender terminal 2 having the electronic business card managing application 6 which is loaded therein to determine whether a telephone number of a corresponding receiver is already stored in a telephone number directory of a sender, and send the electronic business card to only a receiver terminal 4 of which the telephone number is not yet stored, on requesting a transmission of a short message receiving signal or a telephone call signal to the receiver terminal 4; and the receiver terminal 4 having the electronic business card managing application 6 which is loaded therein to output the electronic business card on a screen thereof when the short message receiving signal or the telephone call signal is received from the sender terminal 2 and the sender's electronic business card is received from an electronic business card relay server 10.

The sender terminal 2 and the receiver terminal 4 generally perform a voice communication function and a short message transmitting and receiving function. For this purpose, the sender terminal 2 and the receiver terminal 4 determines whether to send the electronic business card to the opponent on calling for the voice communication or on calling for the short message transmission, first processes the sending of the electronic business card same, and then performs the voice communication function and the short message transmitting and receiving function.

In this case, the determination on whether the sender transmits the electronic business card to the opponent to whom voice communication or short message are transmitted is based on whether the telephone number of the corresponding receiver is a telephone number which is not yet stored in the telephone directory of the sender terminal 2.

That is, as illustrated in FIG. 2, when the telephone number of the opponent is stored in the telephone number directory of the sender, the opponent is highly likely to already store the sender's electronic business card. Therefore, the processing is performed not to transmit the electronic business card.

Further, when the electronic business card is updated, the updated electronic business card is transmitted. Therefore, each electronic business card which is distributed is stored along with information on updated date of version, and thus is updated by the electronic business card managing application 6 when the update is needed.

Therefore, the electronic business card managing application 6 of the sender terminal 2 is an application which is linked with the telephone number directory of the sender stored in the sender terminal 2 to read the telephone number.

Further, the telephone number based management system for transmission of an electronic business card according to the embodiment of the present invention performs processing in such a way that the receiver terminal 4 does not transmit the electronic business card to the sender terminal 2 which is the opponent terminal. Therefore, when getting a phone call from an unknown telephone number such as voice fishing, the inventive management system may prevent the user's electronic business card from being sent to the opponent.

The telephone number based management system for transmission of an electronic business card according to the embodiment of the present invention adopts a scheme of directly transmitting, by the electronic business card managing application 6 included in the sender terminal 2, the electronic business card produced as an SMS or MMS file to the receiver terminal 4.

Therefore, the telephone number based management system for transmission of an electronic business card according to the embodiment of the present invention includes the electronic business card relay server 10 configured to receive a request signal for the relay of the electronic business card from the sender terminal 2 and transmit the electronic business card of the corresponding sender to the receiver terminal 4.

That is, the electronic business card relay server 10 may be an SMS server or an MMS server depending on whether the electronic business card is an SMS or MMS.

Further, the electronic business card relay server 10 may also be a server which transmits the electronic business card to the receiver terminal 4 using a push scheme. That is, in the telephone number based management system for transmission of an electronic business card according to the embodiment of the present invention, when the sender terminal 2 requests the electronic business card relay server 10 to transmit the electronic business card, the electronic business card relay server 10 may also use the push scheme among the electronic business card transmission schemes to transmit the electronic business card of the corresponding sender to the specific receiver terminal 4.

In this case, it is preferable that the electronic business card relay server 10 stores the user's electronic business card matching the user's telephone number, and communicates with the electronic business card managing applications 6 loaded in the sender and receiver terminals to interfaceably access them.

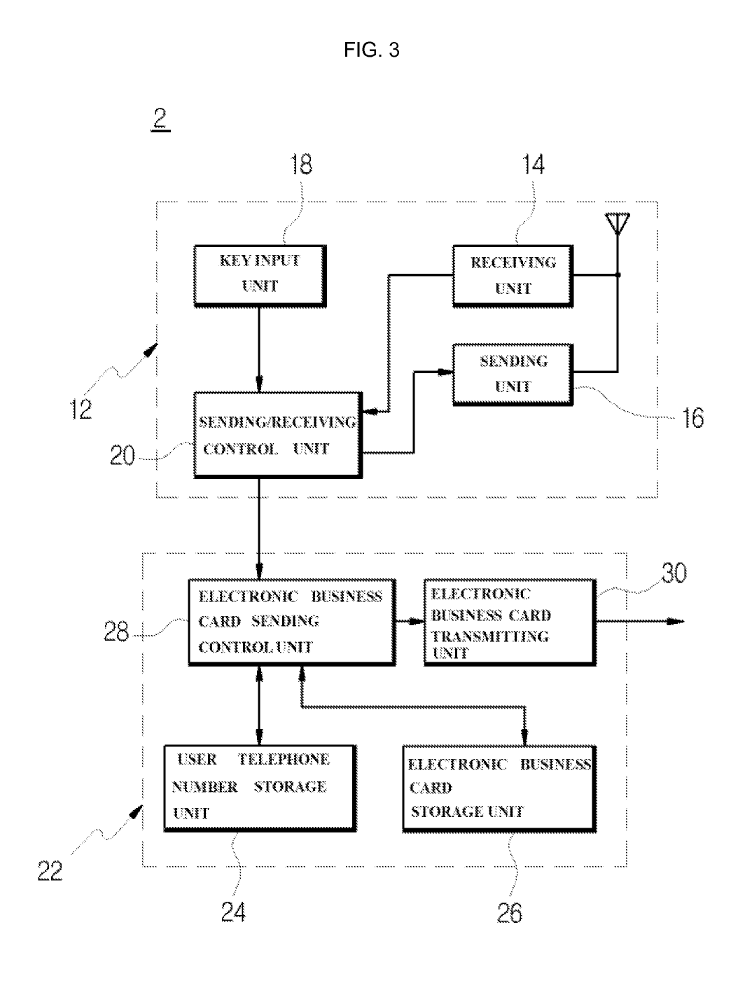

FIG. 3 is a block diagram illustrating a configuration of the user terminal included in the telephone number based management system for transmission of an electronic business card according to the embodiment of the present invention.

Referring to FIG. 3, the user terminal included in the telephone number based management system for transmission of an electronic business card according to the embodiment of the present invention, in particular, the sender terminal 2 includes a general telephone communication function and an automatic electronic business card managing function, and is operated by linking the telephone communication function with the electronic business card managing function. Hereinafter, the configuration thereof will be separately described.

Meanwhile, the electronic business card managing function is performed by the electronic business card managing application 6 which is a software, but is illustrated as a block diagram for visual illustration.

A telephone communication unit 12 included in the sender terminal 2 includes: a key input unit 18 configured to input a telephone number of a specific opponent and generate a telephone call signal or a short message sending request signal; a receiving unit 14 and a sending unit 16 which are configured to process the receiving and sending of the voice communication or the short message transmission and reception; and a receiving/sending control unit 20 configured to generate a receiving or sending signal to the receiving unit 14 and the sending unit 16.

Further, the digital business managing unit 22 included in the sender terminal 2 includes: a user telephone number storage unit 24 configured to store telephone numbers of a plurality of acquaintances; an electronic business card storage unit 26 which stores a sender's electronic business card; an electronic business card sending control unit 28 configured to receive a signal of voice communication and short message transmission and reception from the receiving/sending control unit 20 to determine whether the telephone number of the corresponding receiver is present in the user telephone number storage unit 24 and control so as to transmit the electronic business card if it is determined that the telephone number of the corresponding receiver is not present therein; and an electronic business card transmitting unit 30 configured to transmit the electronic business card.

The function and operation of the telephone number based management system for transmission of an electronic business card according to the embodiment of the present invention, which has the above-described configuration, and the method thereof will be described with reference to the accompanying drawings.

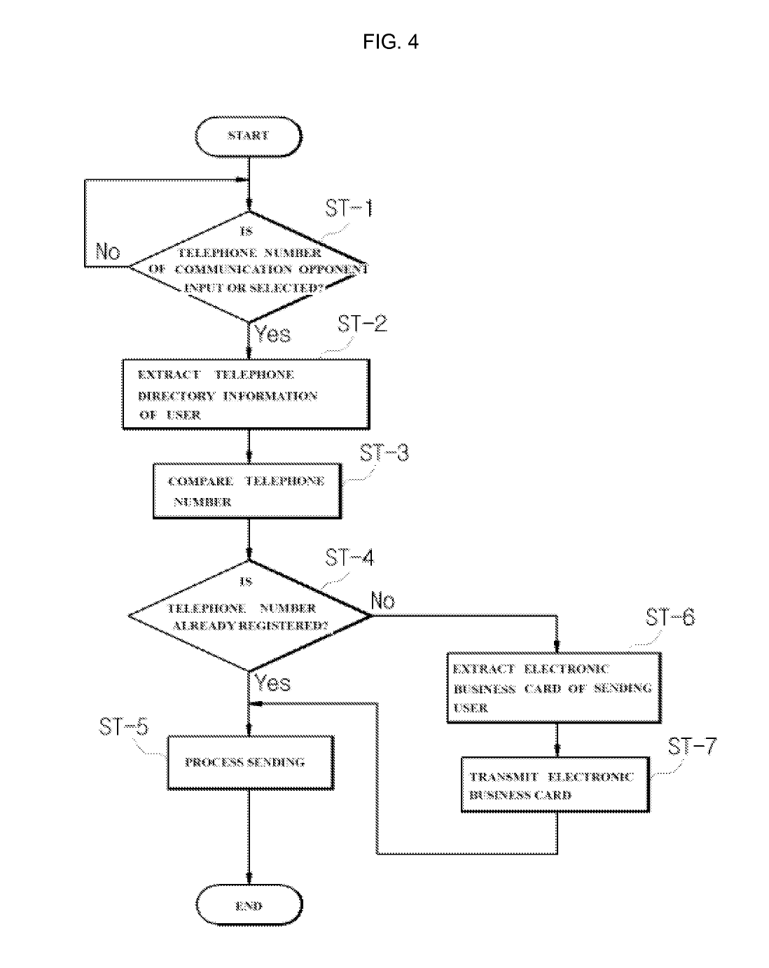

FIG. 4 is a flow chart illustrating a step of transmitting and processing, by the telephone number based management system for transmission of an electronic business card according to the embodiment of the present invention, the electronic business card based on a telephone directory.

First, the sender directly registers the electronic business card formed of SMS or MMS data in the sender terminal included in the telephone number based management system for transmission of an electronic business card according to the embodiment of the present invention. The electronic business card is stored to be extracted by the electronic business card managing application 6 loaded in the sender terminal 2.

In this state, the sender inputs the telephone number of the receiver terminal 4 with which he wants to communicate or transmit short messages through the sender terminal 2 to determine whether the corresponding sender terminal 2 receives the telephone number or receives a telephone number selecting signal.

When receiving the telephone number for communication or short message transmission, the electronic business card managing application 6 of the sender terminal 2 determines whether the opponent user is an object to whom the electronic business card is transmitted.

That is, the electronic business card managing application 6 loaded in the sender terminal 2 compares the telephone number of the opponent user with the telephone number stored in the telephone number directory of the sender and determines whether the corresponding telephone number is a telephone number stored in the telephone number directory of the sender.

If the sender terminal 2 determines that the corresponding telephone number is a telephone number which is not stored in the telephone number directory of the sender, the sender terminal 2 determines that the corresponding receiver is a recipient to whom the electronic business card is transmitted.

On the other hand, if it is determined that the opponent user is not an object to whom the electronic business card is transmitted, the sender terminal 2 performs communication or transmission of short messages.

If it is determined that the opponent user is an object to whom the electronic business card is transmitted, the sender terminal 2 transmits the electronic business card to the corresponding receiver terminal 4 and performs communication or transmission of short messages.

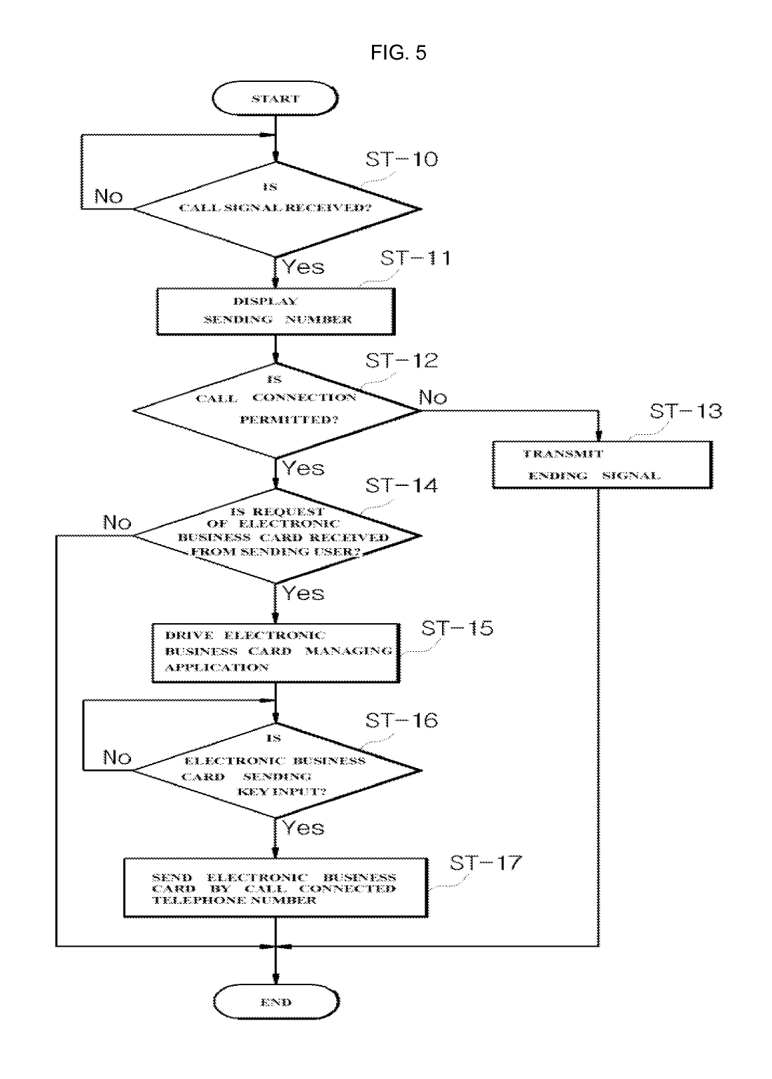

FIG. 5 is a flow chart illustrating a step of transmitting the electronic business card through applications included in the telephone number based management system for transmission of an electronic business card according to the embodiment of the present invention.

First, a receiver may operate the electronic business card managing application 6 included in the telephone number based management system for transmission of an electronic business card according to the embodiment of the present invention to request a sender to transmit the electronic business card.

The sender may recognize or may not recognize the electronic business card requesting information of the receiver through the electronic business card managing application 6 included in the sender terminal 2. That is, when a plurality of receivers request the electronic business card, the sender can be good not to know or to know which of a receiver requests the sender's electronic business card.

For simple convenience, the sender terminal 2 and the receiver terminal 4 included in the telephone number based management system for transmission of an electronic business card according to the embodiment of the present invention may be transmit and receive the electronic business card therebetween by making the electronic business card managing applications 6 each loaded therein communicate with each other.

Of course, the signal requesting the electronic business card needs to be generated by the direct operation of the receiver.

Further, the sender terminal 2 and the receiver terminal 4 have a manual transmitting function provided in the electronic business card managing application 6 so as to transmit the electronic business card to the opponent terminal by a key operation, on the separate request of the communication opponent.

In more detail, when the receiver terminal 4 included in the telephone number based management system for transmission of an electronic business card according to the embodiment of the present invention receives a call signal, a sending number is displayed on the terminal.

In this case, when the receiver permits a call connection by operating a call button of the receiver terminal 4, the receiver terminal 4 determines whether the electronic business card requesting signal is received from the corresponding sender terminal 2. That is, both of the sender and the receiver may request the electronic business card to the opponent terminal.

When the receiver terminal 4 receives the electronic business card requesting signal from the corresponding sender terminal 2, the electronic business card managing application 6 loaded in the corresponding receiver terminal 4 is driven. In this case, for the receiver to recognize the request information, the request information is automatically output on the screen or the electronic business card is automatically extracted and sent.

When the request information is output on the screen for the receiver to recognize the request information, the electronic business card managing application 6 loaded in the corresponding receiver terminal 4 determines whether an electronic business card transmission permitting signal of the receiver is applied.

When the permitting signal is applied, the electronic business card managing application 6 loaded in the corresponding receiver terminal 4 transmits the receiver's electronic business card to the corresponding sender terminal 2.

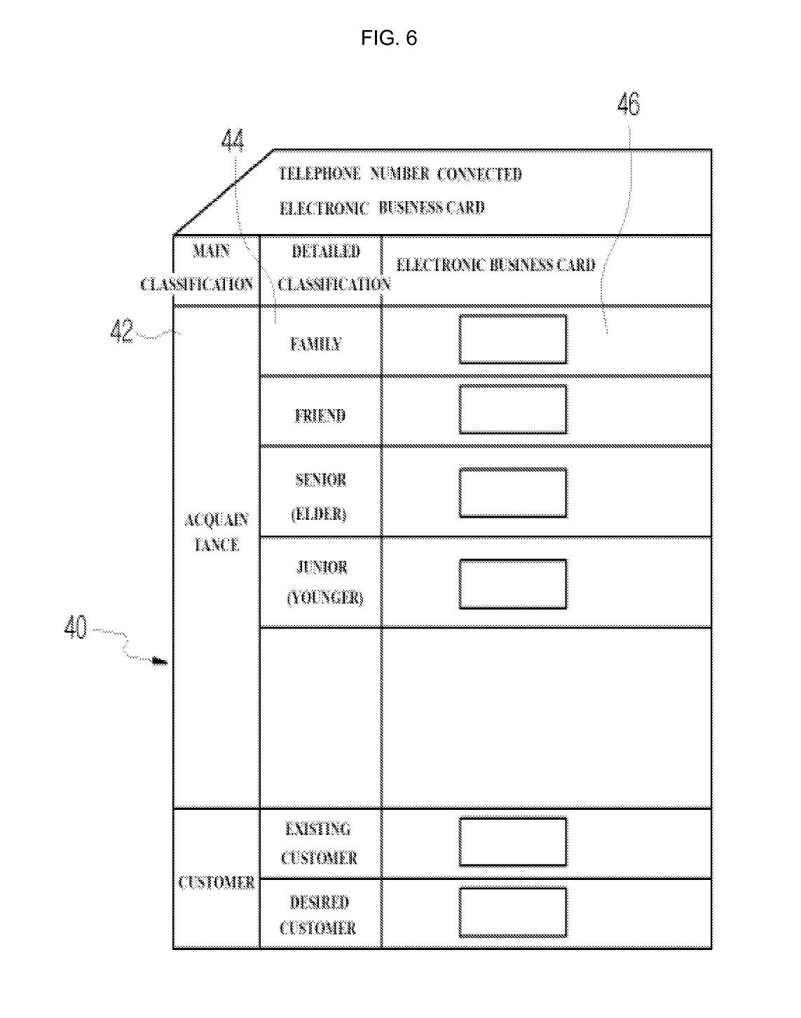

FIG. 6 is a diagram illustrating the state in which the electronic business cards for each relationship with the user are built by the telephone number based management system for transmission of an electronic business card according to the embodiment of the present invention.

Referring to FIG. 6, the telephone number based management system for transmission of an electronic business card according to the embodiment of the present invention transmits the electronic business card, with various electronic business cards for each relationship classified in the telephone directory being already stored. This function transmits the electronic business cards matching the corresponding classification to the user when a telephone number of a specific user stored in a new telephone directory is stored, and thus the convenience is very high.

For example, under the assumption that the user terminal is the sender terminal 2, the sender terminal 2 includes a table 40 in which the electronic business card linked with the telephone directory is stored.

Preferably, the table 40 is divided into a relationship classification table. The table 40 is a table which is built in the electronic business card storage unit 26 illustrated in FIG. 3 and includes a plurality of electronic business card storage columns 46. The electronic business card storage column 46 is formed of a main classification and a detailed classification, in which the main classification 42 is divided into an acquaintance classification and a customer classification. The detailed classification 44 of the acquaintance classification is specifically divided into a family, a friend, a senior, a junior, and the like, and thus may transmit various electronic business cards.

Therefore, the electronic business card sending control unit 28 illustrated in FIG. 3 determines which detailed classification the telephone number of the opponent belongs to and performs a control to extract and transmit the corresponding electronic business card.

Further, the detailed classification of the customer included in the electronic business card storage unit 26 is divided into the existing customer and a desired customer, and thus stores various electronic business cards. Therefore, the electronic business card sending control unit 28 determines which detailed classification the telephone number of the opponent belongs to and performs a control to extract and transmit the corresponding electronic business card.

Therefore, when the telephone number based management system for transmission of an electronic business card according to the embodiment of the present invention is in a situation to transmit the electronic business card, the electronic business card managing application 6 of the sender terminal 2 determines whether the telephone number of the receiver terminal 4 belongs to any classification of the telephone directory of the sender terminal 2, and extracts and transmits the electronic business cards stored depending on the corresponding classification.

Meanwhile, the telephone number based management system for transmission of an electronic business card according to the embodiment of the present invention very conveniently stores a new telephone number.

That is, the electronic business card managing application 6 automatically extracts and transmits the electronic business card matching the classification to which the corresponding telephone number belongs without worrying about what electronic business card needs to be transmitted, by setting only the classification at the time of storing the new telephone number. Therefore, the use convenience is high.

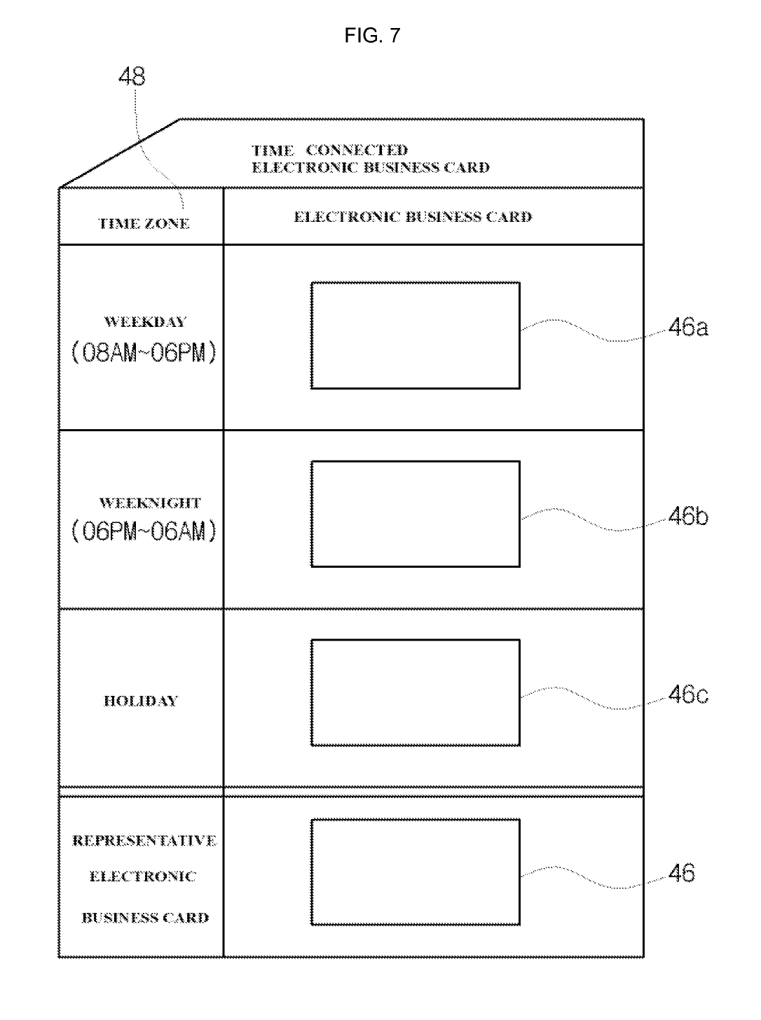

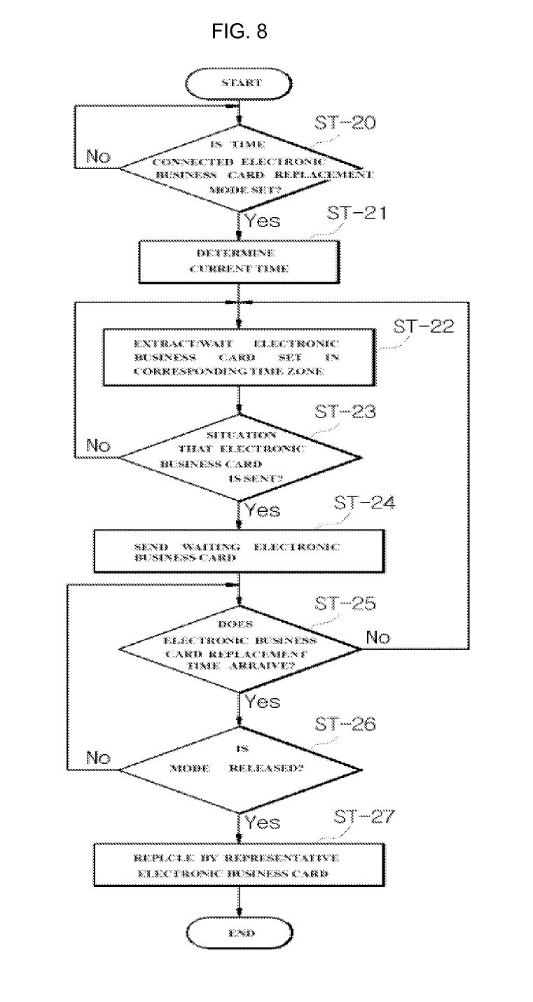

FIG. 7 is a diagram illustrating a state in which the electronic business cards to be transmitted at each time zone is built by the telephone number based management system for transmission of an electronic business card according to the embodiment of the present invention, and FIG. 8 is a flow chart illustrating a step of transmitting the electronic business cards at each time zone by the telephone number based management system for transmission of an electronic business card according to the embodiment of the present invention.

Referring to FIGS. 7 and 8, telephone number based management system for transmission of an electronic business card according to the embodiment of the present invention has a function of selecting any one of a general mode and a time connected electronic business card replacement mode, with a representative electronic business card transmitted by a user regardless of a time zone and electronic business cards different at each time zone being respectively stored in order to transmit various electronic business cards.

For this purpose, the sender terminal 2 includes the electronic business card managing application 6 for managing the electronic business card to automatically replace the electronic business card depending on the time. As illustrated in FIG. 3, the sender terminal 2 includes: the electronic business card storage unit 26 for storing the representative electronic business card and storing various electronic business cards depending on each time zone of weekday, weeknight, and holiday; and the electronic business card sending control unit 28 which determines whether the telephone number of the opponent belongs to any time zone to control so as to extract and transmit the corresponding electronic business card.

The electronic business card storage unit 26 includes a time connected electronic business card table, and connects and stores various electronic business cards 46a, 46b, 46c, and 46d depending on a time connected classification 48.

Describing the operation of the telephone number based management system for transmission of an electronic business card according to the embodiment of the present invention, the electronic business card managing application 6 of the sender terminal 2 determines whether the time connected electronic business card replacement mode is set. In this case, the electronic business card managing application 6 of the sender terminal 2 may determine whether the time connected electronic business card replacement mode is set by the key operation of the sender.

If it is determined that the time connected electronic business card replacement mode is set, the electronic business card managing application 6 of the sender terminal 2 determines whether the current time belongs to any time zone.

Further, the electronic business card managing application 6 of the sender terminal 2 extracts the electronic business card matching the corresponding time zone and then waits.

Preferably, various electronic business cards are stored by matching the time zone of weekday, weeknight, holiday, and the like.

If the situation that the electronic business card needs to be transmitted to any one of the receiver terminals 4 occurs, the electronic business card managing application 6 of the sender terminal 2 transmits the electronic business card, which is matched the corresponding time zone and prepared beforehand, to the corresponding receiver terminal 4.

Further, the electronic business card managing application 6 of the sender terminal 2 checks the time in real time to determine whether the time zone is changed, and if it is determined that the time zone is changed, replaces the electronic business card by another electronic business card and then waits.

Meanwhile, the electronic business card managing application 6 of the sender terminal 2 determines whether a time connected electronic business card replacement mode release signal is received from the key input unit. In this case, when the release signal is received, the electronic business card managing application 6 of the sender terminal 2 extracts the representative electronic business card and then waits.

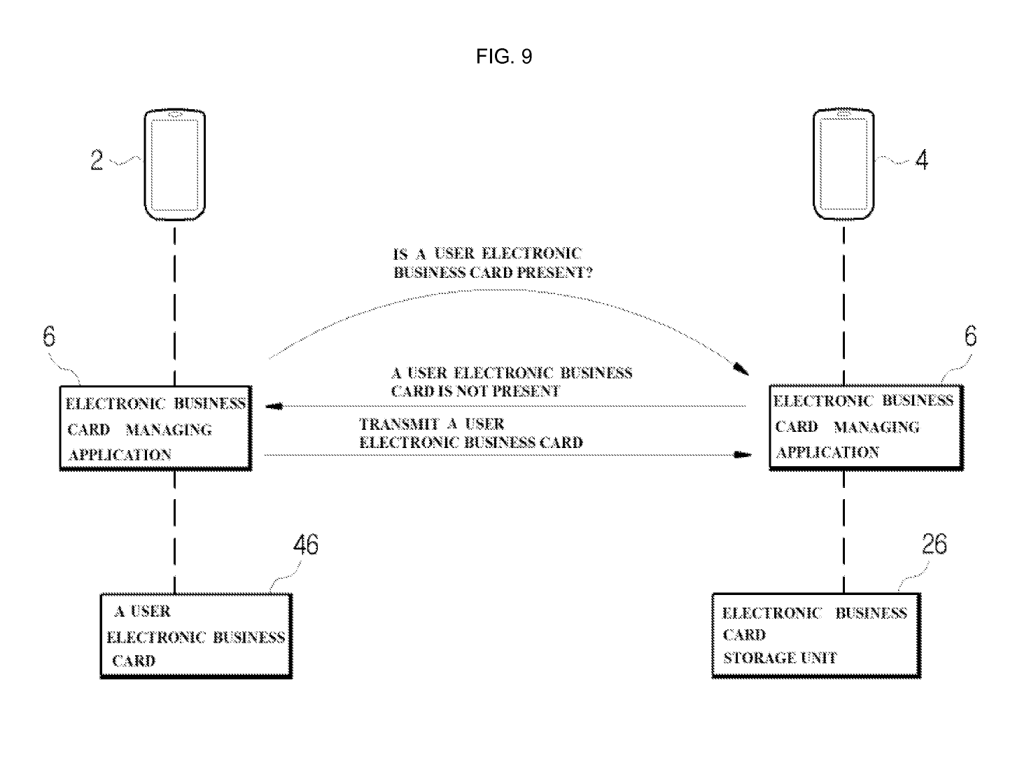

FIG. 9 is a diagram for describing another function of digital business managing applications included in the telephone number based management system for transmission of an electronic business card according to the embodiment of the present invention.

Referring to FIG. 9, in the telephone number based management system for transmission of an electronic business card according to the embodiment of the present invention, as described above, the sender terminal 2 performs a function of transmitting an electronic business card as long as the telephone number of the receiver is not present in the telephone directory stored in the sender terminal 2.

Additionally, referring to FIG. 9, the telephone number based management system for transmission of an electronic business card according to the embodiment of the present invention has a function of further determining whether the sender's electronic business card is stored in the corresponding receiver terminal 4 and transmitting, by the electronic business card managing application 6 of the sender terminal 2, an electronic business card as long as the electronic business card is not stored.

For this purpose, the sender terminal 2 and the receiver terminal 4 communicate with each other through the electronic business card managing application 6 loaded therein. Even when the version of the electronic business cards 46 are different from each other, the electronic business card is sent.

More preferably, it is quickly determined whether the electronic business card of the corresponding sender is present in the receiver terminal 4 by assigning a unique number to the electronic business card to compare only index information of the electronic business card storage unit of the receiver in which the electronic business card is stored.

While the telephone number based management system for transmission of an electronic business card according to the embodiment of the present invention and the method thereof have been described, it will be understood by those skilled in the related art that various modifications and variations may be made therein without departing from the scope of the present invention as defined by the appended claims.

1. A management system for transmission of an electronic business card based on a telephone number, comprising:
a sender terminal including an electronic business card managing application which is loaded therein to determine whether a telephone number of a receiver is already stored in a telephone number directory of a sender, and send an electronic business card to only a receiver terminal of which the telephone number is not yet stored, on requesting a transmission of a short message receiving signal or a telephone call signal to the receiver terminal;
the receiver terminal including the electronic business card managing application which is loaded therein to output the electronic business card on a screen thereof when the short message receiving signal or the telephone call signal is received from the sender terminal and the sender's electronic business card is received from an electronic business card relay server, and
the electronic business card relay server configured to receive a request signal for the relay of the electronic business card from the sender terminal and transmit the electronic business card of the corresponding sender to the receiver terminal.

2. The system according to claim 1, wherein the electronic business card managing application of the sender terminal is an application which is linked with the telephone number directory of the sender stored in the sender terminal to read a telephone number.

3. The system according to claim 1, wherein the sender terminal comprises: a telephone communication unit which includes a key input unit configured to input a telephone number of a specific opponent and generate a telephone call signal or a short message sending request signal, a receiving unit and a sending unit configured to process the receiving and sending of the voice communication or short message transmission and reception, and a receiving/sending control unit configured to generate a receiving or sending signal to the receiving unit and the sending unit; and
a digital business managing unit which includes a user telephone number storage unit configured to store telephone numbers of a plurality of acquaintances, an electronic business card storage unit configured to store a sender's electronic business card, an electronic business card sending control unit configured to receive a signal of voice communication or short message transmission and reception from the receiving/sending control unit to determine whether the telephone number of the corresponding receiver is present in the user telephone number storage unit, and control so as to transmit the electronic business card if it is determined that the telephone number of the corresponding receiver is not present therein; and an electronic business card transmitting unit configured to transmit the electronic business card.

4. The system according to claim 1, wherein the receiver terminal is configured to transmit the electronic business card to the sender terminal when receiving the signal of the voice communication or the short message reception.

5. The system according to claim 1, wherein the sender terminal and the receiver terminal have a manual transmitting function provided in the electronic business card managing application so as to transmit the electronic business card to the opponent terminal by a key operation, on the separate request of the communication opponent.

6. The system according to claim 3, wherein the electronic business card storage unit is configured to store various electronic business cards for each detailed classification of a family, a friend, a senior, and a junior, and
the electronic business card sending control unit is configured to determine whether the telephone number of the opponent belongs to any detailed classification, and control so as to extract and transmit the corresponding electronic business card.

7. The system according to claim 3, wherein the electronic business card storage unit is configured to store various electronic business cards for each detailed classification of an existing customer and a desired customer, and
the electronic business card sending control unit is configured to determine whether the telephone number of the opponent belongs to any detailed classification, and control so as to extract and transmit the corresponding electronic business card.

8. The system according to claim 1, wherein the electronic business card managing application included in the sender terminal is configured to manage the electronic business card to automatically replace the electronic business card by another electronic business card depending on time.

9. The system according to claim 8, wherein electronic business card storage unit included in the sender terminal is configured to store a representative electronic business card and store various electronic business cards at each time zone of weekday, weeknight, and holiday; and
the electronic business card sending control unit is configured to determine whether the telephone number of the opponent is included in any time zone, and control so as to extract and transmit the corresponding electronic business card.

10. The system according to claim 1, wherein the sender terminal and the receiver terminal communicate with each other by the electronic business card managing application loaded therein, and confirm whether the electronic business card of the sender is stored in the receiver terminal to prevent the electronic business card from being repeatedly sent.

11. The system according to claim 1, wherein the electronic business card relay server is an SMS server or an MMS server.

12. The system according to claim 1, wherein the electronic business card relay server transmits the electronic business card to the receiver terminal by a push scheme.

13. An electronic business card transmission-managing method, comprising:
a first step of receiving, by a sender terminal, a telephone number of an opponent user to whom voice communication or short message is transmitted;
a second step of determining, by the sender terminal, whether the opponent user is an object to whom the electronic business card is transmitted;
a third step of performing, by the sender terminal, the transmission of voice communication or short message if it is determined that the opponent user is not the object to whom the electronic business card is transmitted, and
a fourth step of transmitting, by the sender terminal, the electronic business card to the corresponding receiver terminal if it is determined that the opponent user is the object to whom the electronic business card is transmitted, and performing the transmission of voice communication or short message.

14. The method according to claim 13, further comprising: before the first step, registering, by the sender terminal, the electronic business card.

15. The method according to claim 13, wherein the second step comprises:
a step of comparing, by the electronic business card managing application loaded in the sender terminal, the telephone number of the opponent user with the telephone number stored in a telephone directory of the sender;
a step of determining whether the corresponding telephone number is stored in the telephone directory of the sender;
a step of determining the corresponding telephone number to be an object to whom the electronic business card is transmitted if it is determined that the corresponding telephone number is not stored in the telephone directory of the sender.

16. The method according to claim 13, wherein the second step determines the opponent user to be the object to whom the electronic business card is transmitted when the sender terminal receives an electronic business card request signal from the receiver terminal.

17. The method according to claim 13, wherein the second step determines the opponent user to be the object to whom the electronic business card is transmitted when the electronic business card is not stored in the receiver terminal, by the communication between the electronic business card managing application loaded in the sender terminal and the receiver terminal.

18. The method according to claim 13, wherein the fourth step comprises:
a step of determining, by the electronic business card managing application of the sender terminal, whether the telephone number of the receiver terminal belongs to any classification of the telephone number directory of the sender terminal; and
a step of extracting the electronic business card stored in each corresponding classification.

19. The method according to claim 18, wherein the classification of the telephone directory of the sender terminal is divided into a family, a friend, a senior, a junior, an exist customer, and a desired customer.

20. The method according to claim 13, wherein the fourth step comprises:
a step of determining, by the electronic business card managing application of the sender terminal, whether a time connected electronic business card replacement mode is set;
a step of determining whether a current time belongs to any time zone; and
a step of extracting the electronic business card matched the corresponding time zone.

21. The method according to claim 20, wherein various electronic business cards are stored by matching the time zone of a weekday, a weeknight, and a holiday.

22. The method according to claim 20, further comprising: a step of extracting, by the electronic business card managing application of the sender terminal, a representative electronic business card, on releasing the time connected electronic business card replacement mode.
